(19) United States
(12) Patent Application Publication
(10) Pub. No.: US 2014/0291240 A1
(43) Pub. Date: Oct. 2, 2014

(54) Systems, Methods, and Compositions for Clarifying Drilling Mud

(71) Applicant: BLUE EAGLE HOLDINGS, LLC, LAFAYETTE, LA (US)

(72) Inventor: Jurgen D. Scheide, Summit, NJ (US)

(73) Assignee: BLUE EAGLE HOLDINGS, LLC, LAFAYETTE, LA (US)

(21) Appl. No.: 14/229,682

(22) Filed: Mar. 28, 2014

Related U.S. Application Data
(63) Continuation-in-part of application No. 13/624,094, filed on Sep. 21, 2012.
(60) Provisional application No. 61/537,246, filed on Sep. 21, 2011.

(51) Int. Cl. C10M 175/00; C09K 3/32

(52) U.S. Cl. CPC C10M 175/005; C10M 175/0058; C09K 3/32
USPC 210/638; 210/205; 210/177; 252/60

(57) ABSTRACT

Methods, systems, and compositions for clarifying drilling mud are provided. A method of clarifying drilling mud includes at least: mixing a hydrophilic solution and an effluent; the effluent comprising an oil lubricant and solid particles; binding the solid particles to the hydrophilic solution; separating the oil lubricant from the solid particles; and recovering the oil lubricant. A system includes at least: a mixing tank for mixing a hydrophilic solution and an effluent, the effluent comprising an oil lubricant and solid particles, and creating a mixture; and a centrifuge connected to the mixing tank, the centrifuge being capable of receiving the mixture and separating the hydrophilic solution, the solid particles, and the oil lubricant, and discharging the separated oil lubricant. A composition for clarifying drilling mud includes at least: a homogeneous mix of at least one hydrophilic substance.

### CROSS-REFERENCE TO RELATED APPLICATIONS

The present application is a continuation-in-part of U.S. non-provisional patent application Ser. No. 13/624,094, filed on Sep. 21, 2012, which claimed the benefit of U.S. provisional application No. 61/537,246, filed Sep. 21, 2011, the entirety of which are incorporated herein by reference.

### FIELD OF THE INVENTION

The present invention relates generally to systems, methods, and compositions for the clarification and separation of oil-based lubricants from drilling mud, and in particular though non-limiting embodiments, to systems, methods, and compositions for the clarification and separation of oil-based lubricants from drilling mud using a hydrophilic liquid or solution.

### BACKGROUND OF THE INVENTION

In the oil and gas exploration industry, drilling is used to reach layers of fossil fuel deposits, either on-shore or off-shore. One of the important components of the drilling equipment is the rig, which includes the extendible drilling shaft and the drill bit. The drill bit is attached to the end of the drill and acts to cut up the rock. The drill bit only works efficiently if it is properly lubricated.

Lubrication liquids used for lubricating the drill bit or other drill components can be either water-based or oil-based. During oil-based drilling, typical lubricants used are diesel oil, synthetic oil, biodiesel, or other similar organic hydrocarbons, or triglycerides. The lubricant is pumped downward into the hollow drilling shaft and sprayed onto the rotating drill bit, thus providing cooling and lubrication.

Depending on the geological structure of the drilling location, ground minerals and other fine drilling debris of the tectonic layers are mixed and suspended with the lubricant, producing drilling mud. This mud is pushed upward to the surface on the outside of the drilling shaft. For environmental and economic reasons, the drilling mud is collected and clarified from major sediments, which in the oil industry are known as cuttings. These drilling cuttings contain coarse particles of rock, sand, and other minerals, as well as very fine particles down to the size of about 5 microns or even smaller. These fine particles are called “low gravity solids.”

Low gravity solids in oil-based mud include tiny ball-like particles of barite, bentonite, and other minerals. They are formed due to the grinding action of the drill bit as well as the mechanical action of the mud pumps and other drilling equipment. Low gravity solids typically have a large surface area. Thus, these small particles are surrounded by large films of the lubricant and held in suspension. They do not agglomerate due to their like charges.

In order to reuse the oil-based lubricant, the drilling mud is processed to reduce the amount of sediments contained in the mud. One method known in the oil industry uses a three stage clarification process as follows:
a) In the first stage, the oil-based mud is pumped onto vibrating sifters to remove coarse particles.
b) The out-flowing oil mud is then separated, based on differences in specific gravity or density. This is accomplished by liquid-solid separation centrifuges, which in the industry are known as “decanters.” Separation takes place in two stages:
   b1) Using gravitational forces created by a decanter rotating at speeds of between about 1,000 and 2,000 rotations per minute (rpm), and
   b2) Using gravitational forces created by a second decanter rotating at speeds of between about 2,000 and 3,000 rpm.

The resulting oil mud after stage b2) is recycled to the drilling components for re-use.

A common system for employing the three stage clarification process described above is shown in FIG. 1. As shown in FIG. 1, drilling mud flows from a well (visually depicted by arrow 1, e.g., via a path, pipe, channel, etc.) into one or more vibrating sifters 2 such that the larger debris is discharged via a path, pipe, channel, or other similar conduit 4 known in the art. The flow from the well 1 is at a temperature of about 120° F.-140° F., at a rate of about 200-250 gallons per minute (gpm). The remaining drilling mud is passed from the one or more vibrating sifters 2 into a first decanter 6 via a connection 8. The first decanter 6 is used to remove and recover heavier solids, such as, but not limited to, barite. These heavier solids are discharged from the first decanter 6 out of exit 10 such that the remaining portion of the drilling mud in the first decanter 6 defines a first effluent comprising: (i) solid materials or fines that are smaller than the heavier solids previously removed; and (ii) the oil lubricant, such as, but not limited to, diesel oil.

The first effluent is passed from the first decanter 6 into a second decanter 14 through connection 12. Any solids that are separated from the first effluent are discharged via exit 16 of the second decanter 14, and the remaining effluent (referred to as the second effluent) is typically recycled and sent back to the well via a path, pipe, channel, or other similar conduit 18 known in the art to lubricate the drilling components.

However, the use of the second decanter 14 does not fully accomplish its purpose of clarifying the oil lubricant from the remaining solids and fines of the first effluent after the first decanting step.

The oil drilling industry faces substantial technical and economic problems with the aforementioned recovery process. Repeated clarification results in ever increasing concentration of fine sediment material with a size of about 5 microns or less, which, so far, cannot be satisfactorily removed from the oil lubricants.

The ever-increasing concentration of fine solids leads to disastrous results. For example, the out-flowing oil mud becomes so heavy and viscous after the effluent is recycled one or more times that the drilling shaft becomes stuck and can no longer rotate or move. In many cases, the entire shaft and the very valuable drilling bit cannot be removed and are, consequently, lost entirely.

In other cases, it takes incredible efforts to finally recover the drilling shaft and the drill bit. Therefore, substantial time and money are lost.

In addition, very often a completely new hole must be drilled to reach the fuel-bearing layers underground, especially when the entire shaft and/or the drill bit are stuck underground and, therefore, must be abandoned.

Another problem faced in the oil drilling industry is blowouts. As a drilling hole deepens, formation pressures increase, which leads to blowouts. To suppress these high formation pressures and to avoid blowouts, barite is used as a weighting agent for drilling fluids. As the hole is drilled, the bit passes through various geologic formations, each with different characteristics. The deeper the hole, the more barite that is needed as a percentage of total lubricant mix. However, the use of barite further increases the amount of solids in the drilling mud and adds to the problems created by heavy and viscous oil mud.

Table 1 provides technical data of the described conventional process:

TABLE 1
Typical analytical data of Drilling Oil Mud - 100% Diesel
A)

| | |
|---|---|
| 1. Flow out temperature from well, ° F. | 120-140 |
| 2. Mud weight from well, pound per gallon (ppg) | 15.8-15.9 |
| 3. Mud density, grams per cubic centimeter (g/cc) | 1.892-1.905 |
| 4. Solids content, % by volume | 36 |
| 5. Oil content, % by volume | 60 |
| 6. Water content, % by volume | 4 |

B) Barite Recovery Step (First Decanter)

| | |
|---|---|
| 1. Flow in temperature, ° F. | 110-120 |
| 2. Flow out temperature, ° F. | 100-110 |
| 3. Mud weight in, ppg | 15.8-15.9 |
| 4. Mud density in, g/cc | 1.892-1.905 |
| 5. Mud weight out, ppg | 10.5 |
| 6. Mud out density, g/cc | 1.198 |
| 7. Solids content of first effluent, % by volume | 31 |
| 8. Oil content of first effluent, % by volume | 65 |
| 9. Water content of first effluent, % by volume | 4 |

C) High Speed Step (Second Decanter)

| | |
|---|---|
| 1. Flow in temperature, ° F. | 100-110 |
| 2. Flow out temperature, ° F. | 90-100 |
| 3. Mud weight in, ppg | 10.5 |
| 4. Mud density in, g/cc | 1.198 |
| 5. Mud weight out, ppg | 9.5 |
| 6. Mud density out, g/cc | 1.138 |
| 7. Solids content of second effluent, % by volume | 31 |
| 8. Oil content of second effluent, % by volume | 67 |
| 9. Water content of second effluent, % by volume | 2 |

As can be seen from Table 1, in the barite recovery step, the mud weight is reduced from about 15.8-15.9 ppg, to a mud weight of 10.5 ppg. The mud density is reduced from about 1.892-1.905 g/cc, to a mud density of 1.198 g/cc. The solids content is reduced from about 36% to about 31% by volume.

However, the high speed second decanter does not accomplish its purpose of clarifying the diesel oil lubricant from the remaining solids and fines of the effluent after the barite recovery step. Mud weight is only reduced from 10.5 to 9.5 ppg (mud density from 1.198 to 1.138 g/cc). Many solid materials remain in the diesel oil lubricant and, consequently, are recycled to the well.

There is, therefore, a long-standing yet unmet need for improved methods and compositions for clarifying oil mud. There is a further unmet need for systems employing those methods and compositions, such that the undesirable materials, such as the solid materials in the mud, are removed from the oil lubricant before recycling the oil lubricant back to the well.

### SUMMARY

Methods, systems, and compositions for clarifying drilling mud are provided. A method of clarifying drilling mud includes at least the following steps: mixing a hydrophilic solution and an effluent to create a mixture; the effluent comprising an oil lubricant and solid particles; binding the solid particles to the hydrophilic solution; separating the oil lubricant from the solid particles; and recovering the oil lubricant. A system for clarifying drilling mud includes at least: a mixing tank for mixing a hydrophilic solution and an effluent, the effluent comprising an oil lubricant and solid particles, and creating a mixture; and a centrifuge connected to the mixing tank, the centrifuge being capable of receiving the mixture and separating the hydrophilic solution, the solid particles, and the oil lubricant, and discharging the separated oil lubricant. A composition for clarifying drilling mud includes at least: a homogeneous mix of at least one hydrophilic substance.

### BRIEF DESCRIPTION OF THE DRAWINGS

For a further understanding of the nature, objects, and advantages of the present invention, reference should be had to the following description, read in conjunction with the following drawings, wherein like reference numerals denote like elements and wherein:

FIG. 1 illustrates a prior art example of a system for clarifying drilling mud to recover oil-based lubricants.

FIG. 2 illustrates a system for clarifying drilling mud to recover oil-based lubricants, according to example embodiments disclosed herein.

FIG. 3 illustrates a system for clarifying drilling mud to recover oil-based lubricants, according to further example embodiments.

### DETAILED DESCRIPTION

Systems and compositions, and methods of using same, are disclosed herein for clarifying drilling mud and recovering one or more oil lubricants for recycling to a well to lubricate drilling components.

According to example embodiments, methods for the clarification of oil mud are provided. In further embodiments, the clarification process is improved, increasing the number of times the oil lubricants can be recycled to the oil rig.

In example embodiments, achieving more efficient use of such oil lubricants, such as by increasing the number of times such oil lubricants can be recycled, saves substantial expenses related to the introduction and use of fresh lubricant oil, as well as the expenses related to the storage and disposal of unrecoverable drilling mud. In addition, it becomes less likely that drill bits, drilling shafts, or other drilling components are lost, which results in decreased drilling time to reach the fossil fuel, and saves expenses related to: (i) recovering the drill bits, drilling shafts, and other drilling components; (ii) abandoning unrecoverable drill bits and drilling shafts and attaching new drill bits and drilling shafts; and (iii) drilling new holes for new drill bits and shafts in the event that prior holes are unable to be cleared.

According to further example embodiments, separation of diesel oil or other oil lubricants is enhanced when a hydrophilic liquid or solution is introduced into the clarification process.

According to example embodiments, hydrophilic liquids include, but are not limited to, one or more of the following: water, glycerin, propylene glycol (1,2-propanediol) and other water soluble glycols and polyols such as ethylene glycol, xylitol, sorbitol, glucose syrup, fructose syrup, polymerized polyols, etc., as well as solutions of these chemicals in water. According to still further embodiments, solutions of water, glycerin, propylene glycol and one or more polyol syrups are used for separation.

According to example embodiments, oil lubricants include, but are not limited to, diesel oil, or one or more of the following synthetic oil lubricants: ethers, esters, acetals, linear alpha olefins (LAOs), poly alpha olefins (PAOs), linear paraffins, alkylbenzenes, and internal olefins.

According to further example embodiments, oil lubricants also include, but are not limited to, one or more biodiesel oil lubricants, which are triglycerides transesterified with alcohol.

Example embodiments allow for the improved clarification of oil lubricants from drilling mud such that the recovered oil lubricants are recycled to the well and used again for lubrication of the drilling components.

In accordance with some embodiments, methods for clarifying drilling mud and recovering one or more oil lubricants for recycling to a well to lubricate one or more drilling components, include: mixing a hydrophilic liquid or solution with an effluent, the effluent comprising an oil lubricant and solid particles having a predetermined size; binding the solid particles to the hydrophilic liquid or solution; separating the oil lubricant in the effluent from the solid particles; and recovering the separated oil lubricant.

According to example embodiments, the drilling mud or effluent is mixed with the hydrophilic liquid or solution at a temperature of up to about 60° C. (about 140° F.) and is exposed to high gravitational forces.

In other embodiments, methods further comprise: (i) recycling the separated oil lubricant to the well; (ii) discharging the separated solid particles; and (iii) recovering the hydrophilic liquid or solution.

In still other embodiments, methods further comprise recycling and reusing the recovered hydrophilic liquid or solution. In certain embodiments, the recovered hydrophilic liquid or solution is re-used up to four times before losing its efficacy.

According to example embodiments, methods further comprise heating the hydrophilic liquid or solution to about 140° F. before the mixing step. Further example embodiments include mixing the hydrophilic solution in an insulated mixing tank to create a homogeneous mixture.

Still further embodiments include heating and mixing the effluent and hydrophilic liquid or solution to create an even greater difference in the specific gravities of the hydrophilic liquid or solution and the oil lubricant, and as the difference in specific gravities increases, the more efficient the separation.

In certain embodiments, the mixture of hydrophilic liquid or solution and effluent is supplied to at least one centrifuge, such as a tricanter, which separates, recovers, and recycles the oil lubricant. In other embodiments, the at least one centrifuge separates the mixture at about 2,000 to about 3,500 rpm. In still further example embodiments, the at least one centrifuge discharges the hydrophilic liquid or solution under pressure via an adjustment of a centripetal pump connected to the centrifuge. This allows the oil lubricant to discharge cleanly by gravity flow for the recycling thereof.

In other example embodiments, the oil lubricant is hydrophobic, thereby facilitating its separation from the solid particles and the hydrophilic liquid or solution.

In yet other example embodiments, the solid materials comprise fibrous solids, crystalline solids, low gravity solids, low gravity fines, or combinations thereof.

In other embodiments, the mixture formed during the mixing step comprises from about 20 percent to about 30 percent hydrophilic liquid or solution, and from about 70 percent to about 80 percent effluent. In some embodiments, the mixture is about 25 percent to about 30 percent hydrophilic liquid or solution and about 70 percent to about 75 percent effluent. In further embodiments, the mixture is about 20 percent hydrophilic liquid or solution and about 80 percent effluent. In still further embodiments, the mixture is about 25 percent hydrophilic liquid or solution and about 75 percent effluent. In other embodiments, the mixture is about 30 percent hydrophilic liquid or solution and about 70 percent effluent.

According to example embodiments, prior to the mixing step, the effluent passes through at least one vibrating sifter to remove debris or other solid particles larger than a predetermined size.

According to still further example embodiments, prior to the mixing step, a first decanter receives drilling mud from the well and removes solid particles larger than a predetermined size from the mud. According to some embodiments, the first decanter removes barite from the drilling mud, and a first effluent, comprising the oil lubricant and any remaining solid particles, exits the first decanter.

In other embodiments, a second decanter receives the first effluent from the first decanter and removes further solid particles larger than the predetermined size from the first effluent, and a second effluent, comprising the oil lubricant and any still remaining solid particles, exits the second decanter.

In still other embodiments, hydrophilic liquid or solution is mixed with the second effluent in a mixing tank. In some embodiments, the second decanter is not needed for further separation, and in those embodiments, the first effluent is mixed with the hydrophilic liquid or solution in the mixing tank.

According to other example embodiments, prior to entering the first decanter, the drilling mud first passes through one or more vibrating sifters to remove debris or other solid particles larger than the predetermined size.

In other embodiments, the drilling mud flows from the well at a temperature of about 120° F. to about 140° F. and at a rate of about 200 to about 250 gpm.

In still further embodiments, the predetermined size is about 5 microns. In other example embodiments, the predetermined size is less than about 5 microns.

According to example embodiments, a system for clarifying drilling mud and recovering one or more oil lubricants for recycling to a well to lubricate one or more drilling components, comprises:
a mixing tank for receiving a hydrophilic liquid or solution and an effluent comprising an oil lubricant and solid particles having a predetermined size, and for mixing the hydrophilic liquid or solution with the effluent such that the hydrophilic liquid or solution binds to the solid particles; and
at least one centrifuge for receiving the mixture of the hydrophilic liquid or solution and the effluent, for separating the hydrophilic liquid or solution, the solid particles, and the oil lubricant from each other; and for recovering the separated oil lubricant.

In certain embodiments, the centrifuge is a clarifying liquid to liquid disc centrifuge with at least one adjustable solids discharge mechanism. In still other embodiments, the centrifuge is semi-continuous. In still further embodiments, the centrifuge is a continuous centrifuge. In still further embodiments, the centrifuge is a three stage decanter or tricanter.

In other example embodiments, the system further includes at least one decanter for separating the drilling mud prior to mixing the resulting effluent with the hydrophilic liquid or solution in the mixing tank.

According to further embodiments, the system includes two decanters. In embodiments with two decanters, the two decanters operate in series. The second effluent exiting the second decanter is transmitted to the mixing tank, wherein the second effluent is mixed with the hydrophilic liquid or solution.

In example embodiments, the system further includes at least one vibrating sifter, wherein the at least one vibrating sifter receives the drilling mud from the well and removes at least a portion of the debris and solid particles from the drilling mud prior to transmitting the remaining drilling mud or effluent to the at least one decanter or mixing tank.

In certain embodiments, the system includes a means for controlling the flow and temperature of the drilling mud from the well, such that the temperature of the drilling mud is at about 120° F. to about 140° F. and the rate of the mud is about 200 gpm to about 250 gpm.

Other embodiments of the system include means for heating the hydrophilic liquid or solution to about 140° F. before the hydrophilic liquid or solution is introduced into the mixing tank. In some embodiments, the means for heating the hydrophilic liquid or solution is a heat exchanger.

In other example embodiments, the mixing tank is jacketed or insulated. In further embodiments, the hydrophilic liquid or solution is added to the tank and heated. In example embodiments, higher temperature decreases the viscosity of the hydrophilic liquid or solution. In still further embodiments, by maintaining a steady high temperature while mixing, the hydrophilic solution becomes a homogeneous mixture more quickly and more efficiently.

In other example embodiments, the hydrophilic liquid or solution is a homogeneous mixture of one or more of the following: water, glycerin, propylene glycol (1,2-propanediol) and other water soluble glycols and polyols comprising at least one of ethylene glycol, xylitol, sorbitol, glucose syrup, fructose syrup, polymerized polyols, and one or more solutions of glycerin, propylene glycol (1,2-propanediol), water soluble glycols, water soluble polyols, ethylene glycol, xylitol, sorbitol, glucose syrup, fructose syrup, and polymerized polyols in water.

In still other example embodiments, the hydrophilic liquid or solution comprises about 20 percent glycerin and about 80 percent water, with a specific gravity of about 1.047 at 20° C.

In other example embodiments, the hydrophilic solution is about 55 percent water, about 10 percent glycerin, and about 35 percent propylene glycol, with a specific gravity of about 1.046 at 20° C.

In still other embodiments, the hydrophilic solution is about 30 percent water and about 70 percent propylene glycol, with a specific gravity of about 1.042 at 20° C.

In other embodiments, the hydrophilic solution is about 70 percent water and about 30 percent ethylene glycol, with a specific gravity of about 1.050 at 20° C.

In other example embodiments, the hydrophilic solution is about 40 percent water, about 25 percent glycerin, and about 35 percent propylene glycol, with a specific gravity of about 1.086 at 20° C.

In still other embodiments, the solution is about 35 percent water, about 30 percent propylene glycol, and about 35 percent glycerin, with a specific gravity of about 1.104 at 20° C.

In other example embodiments, the solution is about 19.8 percent water, about 38.8 percent propylene glycol, and about 41.4 percent glycerin, with a specific gravity of about 1.141 at 20° C.

In still further example embodiments, the solution is about 46 percent propylene glycol and about 54 percent glycerin, with a specific gravity of about 1.150 at 20° C.

In example embodiments, the solution is about 15 percent water, about 35 percent propylene glycol, and about 50 percent high fructose corn syrup (76° Bx), with a specific gravity of about 1.189 at 20° C.

In still further embodiments, the solution is about 12 percent water, about 28 percent propylene glycol, and about 60 percent high fructose corn syrup (76° Bx), with a specific gravity of about 1.226 at 20° C.

According to still further example embodiments, the hydrophilic solution is formed in a jacketed or insulated mixing tank that operates to heat the solution, thereby increasing the speed to reach the homogeneous mixture.

In certain embodiments, the hydrophilic liquid or solution has a specific gravity of at least about 1.0 at 20° C.

In other embodiments, the hydrophilic liquid or solution comprises bi-polar molecules having at least one hydrophobic group on one side and at least one hydrophilic group on the other side of the molecules. Because the oil lubricant is lighter than the hydrophilic liquid or solution, upon mixing, the oil lubricant forms a continuous oil layer above the heavier hydrophilic liquid or solution. In addition, a border layer forms in which the hydrophobic groups of the hydrophilic solution orient themselves toward the hydrophobic oil lubricant layer, while the hydrophilic groups of the hydrophilic solution orient themselves toward any hydrophilic or water-soluble molecules in the effluent or drilling mud. The hydrophobic groups then replace the solid particles that are suspended in the oil lubricant layer, as the attraction between the hydrophobic oil lubricant and the hydrophobic groups act to separate the oil from the suspended low gravity solids. Similarly, the hydrophilic groups of the hydrophilic solution are attracted to, and thus act to separate, any hydrophilic or water-soluble molecules from the effluent or drilling mud.

In yet other example embodiments, the bi-polar molecules are 1,2-propanediol (also known as propylene glycol). 1,2-propanediol contains one hydrophobic methyl (—CH₃) group on one side of the molecule, and two hydrophilic hydroxyl (—OH) groups on the other side. According to example embodiments, propylene glycol orients itself in the border layer between the hydrophobic oil lubricant and the hydrophilic liquid or solution.

In further embodiments, the oil is separated from the solids and orients itself around the hydrophobic —CH₃ groups to form a continuous oil layer above the heavier hydrophilic liquid or solution.

In further additional embodiments, as the temperature of the mixture increases, the difference in the surface tension of the hydrophilic liquid or solution and the surface tension of the oil lubricant increases, further aiding in separation.

In further example embodiments, while being subjected to gravitational force separation at temperatures of about 60° C. (about 140° F.), propylene glycol firmly remains embedded in the higher specific gravity hydrophilic liquid or solution, whereas the lower specific gravity hydrophobic lubricant is cleanly separated.

According to still further embodiments, the efficiency of the method and system is increased by adjusting the density of the hydrophilic liquid or solution. Such adjustment creates a difference in the densities of the hydrophilic liquid or solution and the oil lubricant. Oil-based lubricants typically have a density of about 0.90 g/cc at 20° C. or less.

According to example embodiments, the oil-based lubricant is separated from any sediments as small as about 5 microns or less by using hydrophilic liquids or their solutions in water with specific gravities of at least 1 at 20° C.

In example embodiments, an efficient separation takes place by vigorously mixing the effluent or drilling mud with the inventive solution at temperatures of up to about 60° C. and exposing the mixture to high gravitational forces.

In further example embodiments, the system uses three-stage decanters, which are known in the industry as tricanters. In example embodiments, the tricanter(s), separate the solids from the liquid phases and simultaneously separate the heavy liquid phase from the light liquid phase. In example embodiments, machines with a centripetal pump system allow a clean separation of the hydrophilic liquid or solution from the drilling oil lubricant. According to still further embodiments, centrifuges are operated in either semi-continuous or completely continuous fashion.

In still further example embodiments, the disclosed hydrophilic solutions are environmentally friendly and do not create any health hazards. In certain embodiments, the hydrophilic liquids are either food ingredients or are considered GRAS (Generally Recognized As Safe) by the Food and Drug Administration (FDA), because they are allowed as food ingredients.

In yet other example embodiments, the disclosed hydrophilic solutions are biodegradable and thus, environmentally friendly. Such example biodegradable substances are propylene glycol, glycerin, glucose syrup, fructose syrup, or mixtures thereof.

Hydrophilic separation solutions with different specific gravities are prepared as follows:

Separation Solution A
800 lb water
200 lb glycerin
1,000 lb liquid; specific gravity: 1.047 (20° C.)

Separation Solution B
550 lb water
100 lb glycerin
350 lb propylene glycol
1,000 lb liquid; specific gravity: 1.046 (20° C.)

Separation Solution C
300 lb water
700 lb propylene glycol
1,000 lb liquid; specific gravity: 1.042 (20° C.)

Separation Solution D
700 lb water
300 lb ethylene glycol
1,000 lb liquid; specific gravity: 1.050 (20° C.)

Separation Solution E
400 lb water
250 lb glycerin
350 lb propylene glycol
1,000 lb liquid, specific gravity: 1.086 (20° C.)

Separation Solution F:
350 lb water
300 lb propylene glycol
350 lb glycerin
1,000 lb liquid, specific gravity: 1.104 (20° C.)

Separation Solution G:
198 lb water
388 lb propylene glycol
414 lb glycerin
1,000 lb liquid, specific gravity: 1.141 (20° C.)

Separation Solution H:
460 lb propylene glycol
540 lb glycerin
1,000 lb liquid, specific gravity: 1.150 (20° C.)

Separation Solution I:
150.0 lb water
350.0 lb propylene glycol
500.0 lb high fructose corn syrup (76° Brix)
1,000 lb liquid, specific gravity: 1.189 (20° C.)

Separation Solution J:
120.0 lb water
280.0 lb propylene glycol
600.0 lb high fructose corn syrup (76° Brix)
1,000.0 lb liquid, specific gravity: 1.226 (20° C.)

### Preparation Instructions:

According to example embodiments, each of the separation solutions is prepared in a jacketed or insulated mixing tank which is equipped with a high-speed mixer. In certain to embodiments, while the ingredients are being mixed, heat is applied to the tank in order to increase the speed to reach a homogeneous mix. In example embodiments, a sample is taken to determine the specific gravity of the liquid (at 20° C.).

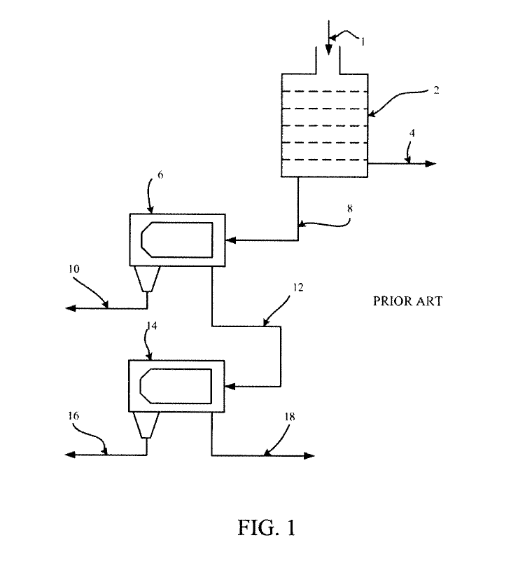

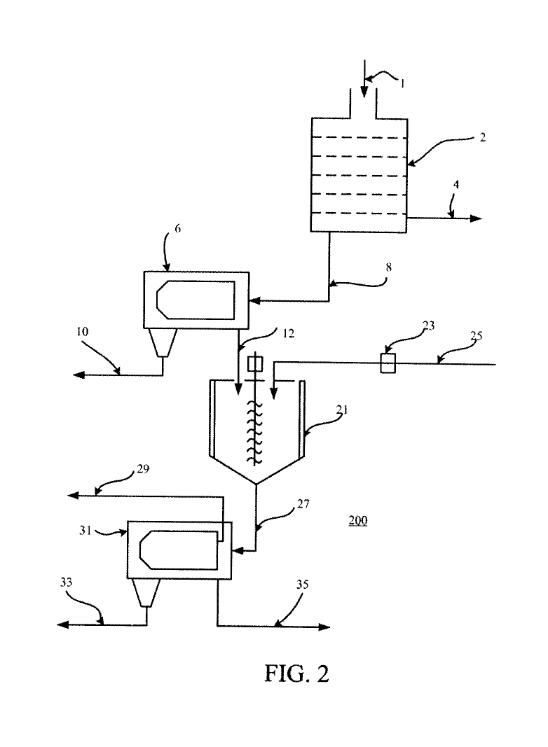

Turning now to FIG. 2, in addition to one or more vibrating sifters 2 and the first decanter 6 (and, in some embodiments, the second decanter 14 as discussed in the “Background of the Invention” section above and in FIG. 1), the system 200 further comprises a mixing tank 21 for receiving the first effluent from the first decanter 6 through connection 12 and for receiving a hydrophilic liquid or solution (e.g., any of any one or more of separation solutions A through J discussed above) therein from input 25. In example embodiments with two decanters, the mixing tank 21 receives the second effluent from the second decanter.

In example embodiments, the mixing tank 21 operates to mix the hydrophilic liquid or solution with the first effluent. In further embodiments, the input path 25 runs through a heat exchanger 23 so that the hydrophilic liquid or solution is at about 140° F. before insertion into the mixing tank 21.

According to example embodiments, the mixing of the hydrophilic liquid or solution with the effluent causes the solid particles having the predetermined size to bind to the hydrophilic liquid or solution. As such, those solid or fine materials become hydrophilic and separate from the oil lubricant, which is naturally hydrophobic.

In further embodiments, the mixture is then sent to a tricanter 31 that operates to: (i) discharge any separated solids or fines (including e.g., fibrous materials or solids, crystalline materials or solids, low gravity solids, low gravity fines, etc.) through output 33 to a storage bin, a container, or a waste disposal system; and (ii) recover the hydrophilic liquid or solution and the clarified oil lubricant.

In further embodiments, the tricanter 31 operates to send the recovered hydrophilic liquid or solution through output 29 to be recycled back into the mixing tank 21 (e.g., by connecting line 29 to line 25 such that the recovered hydrophilic liquid or solution is disposed in line 25), and the tricanter 31 operates to send the clarified oil lubricant through output 35 back to the well for use as a lubricant on the drilling machinery, such as the drill bit.

Additionally, in further example embodiments, the output lines 4 and 10 lead to a respective storage bin, container, waste disposal system, etc. for appropriate processing of the discharged materials.

In further embodiments, the decanters before the mixing tank are not part of the system. In other embodiments, the vibratory sifters are not part of the system.

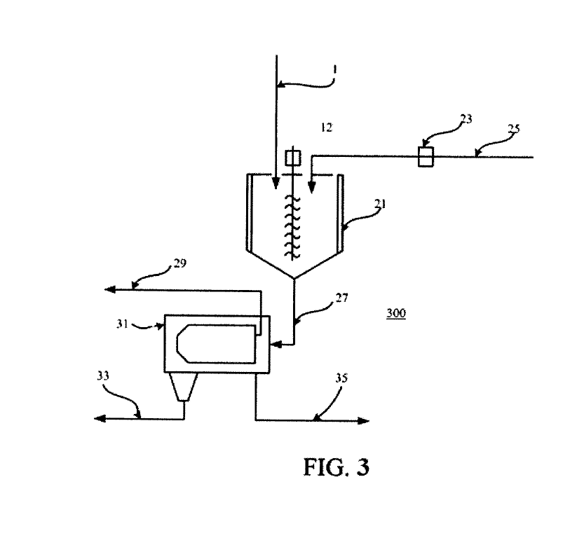

Turning now to FIG. 3, the system 300 comprises a mixing tank 21 for receiving the drilling mud flow 1 directly from the well and for receiving a hydrophilic liquid or solution (e.g., any of any one or more of separation solutions A through J discussed above) therein from input 25.

In example embodiments, the mixing tank 21 operates to mix the hydrophilic liquid or solution with the drilling mud flow 1. In further embodiments, the input path 25 runs through a heat exchanger 23 so that the hydrophilic liquid or solution is at about 140° F. before insertion into the mixing tank 21.

In yet other embodiments, the mixing of the hydrophilic liquid or solution with the drilling mud flow 1 causes the solid particles having the predetermined size to bind to the hydrophilic liquid or solution. As such, those solid or fine materials become hydrophilic and separate from the oil lubricant, which is naturally hydrophobic.

In further embodiments, the mixture is then sent to a tricanter 31 that operates to: (i) discharge any separated solids or fines (including e.g., fibrous materials or solids, crystalline materials or solids, low gravity solids, low gravity fines, etc.) through output 33 to a storage bin, a container, or a waste disposal system; and (ii) recover the hydrophilic liquid or solution and the clarified oil lubricant.

In still other embodiments, the tricanter 31 operates to send the recovered hydrophilic liquid or solution through output 29 to be recycled back into the mixing tank 21 (e.g., by connecting line 29 to line 25 such that the recovered hydrophilic liquid or solution is disposed in line 25), and the tricanter 31 operates to send the clarified oil lubricant through output 35 back to the well for use as a lubricant on the drilling machinery, such as the drill bit.

### Preparation of Drilling Oil Mud for Separation:

### Example 1

In example embodiments, the second effluent, which flows out of the second decanter, has an average temperature of about 100° F. to about 120° F. It is pumped into an insulated mixing tank, which is equipped with a high-speed mixer, and then is mixed with Separation Solution C in the following proportion:
3,000 lb oil mud
1,000 lb Solution C
4,000 lb

In further example embodiments, Solution C is heated to about 60° C. (about 140° F.) in a heat exchanger before entering the mixing tank.

In still further example embodiments, Liquid C and the effluent, which has an average weight of 10.5 ppg, are vigorously mixed to a uniform blend and charged into a tricanter and separated at about 3,000 rpm. In some embodiments, sediment solids, including fine solids, are discharged from the tricanter at the opposite side of the liquid entry. In other embodiments, the heavy-phase Solution C is discharged under pressure by adjusting the centripetal pump in such a way that the light-phase oil lubricant discharges clean by gravity flow.

According to example embodiments, before the clarified lubricant oil (light phase) is recycled to the drill bit, a sample is taken and analyzed for clarity and amount of any residual solids. In certain embodiments, the heavy-phase solution is reused again as hydrophilic separation solution. In other embodiments, the heavy-phase solution is discarded.

Table 2 illustrates the analytical data of the clarified oil lubricant as a result of the above described method.

TABLE 2
Tricanter Effluent/Clarified Oil Lubricant using
Second Effluent and Separation Solution C

| | |
|---|---|
| 1. Flow in temperature tricanter, ° F. | 110-130 |
| 2. Flow out temperature tricanter, ° F. | 100-110 |
| 3. Second effluent weight into mixing tank, ppg | 9.5 |
| 4. Second effluent density into mixing tank, g/cc | 1.138 |
| 5. Clarified Oil weight out, ppg | 7.39 |
| 6. Clarified Oil density out, g/cc | 0.886 |

In example embodiments, the oil mud weight is reduced from about 9.5 ppg to about 7.39 ppg. The density of the clarified oil is measured at about 0.886 g/cc, which is within the density range for diesel oil.

In certain embodiments, only one decanter is used.

In other embodiments, no decanter is used, and the drilling mud proceeds to the mixing tank without any pre-separation. In still further embodiments, no decanter is used, but the drilling mud passes through at least one vibratory sifter before the resulting effluent is sent to the mixing tank.

### Example 2

According to example embodiments, effluent which flows out of the first decanter has an average temperature of about 120° F. and an average weight of about 10.9 ppg. In certain embodiments, the effluent is pumped into an insulated mixing tank, which is equipped with a high-speed mixer, and then is mixed with Liquid F in the following proportion:
2,800 lb oil mud
1,200 lb Solution F
4,000 lb

In still other embodiments, Solution F is heated to about 60° C. (about 140° F.) in a heat exchanger before entering the mixing tank. In some embodiments, Solution F and the effluent are vigorously mixed to a uniform blend and charged into a tricanter and separated at about 3,500 rpm.

In example embodiments, a thick sludge of sediment solids is discharged from the three stage decanter at the opposite side of the liquid entry. In other embodiments, the heavy-phase Solution F is discharged under pressure by adjusting the centripetal pump in such a way that the light-phase oil lubricant discharges clean by gravity flow.

Before the clarified lubricant oil (light phase) is recycled to the drill bit, in example embodiments, a sample is taken and analyzed for clarity and amount of residual solids. In still further embodiments, the heavy-phase solution is reused again as separation solution, or in other embodiments, the heavy-phase solution is discarded.

Table 3 illustrates the analytical data of the clarified oil lubricant as a result of the above-described process.

TABLE 3
Tricanter Effluent/Clarified Oil Lubricant using
First Effluent and Solution F

| | |
|---|---|
| Flow in temperature tricanter, ° F. | 110-130 |
| Flow out temperature tricanter, ° F. | 100-110 |
| First effluent weight into tank, ppg | 10.5 |
| First effluent density into tank, g/cc | 1.258 |
| Clarified Oil weight out, ppg | 7.15 |
| Clarified Oil density out, g/cc | 0.853 |

According to example embodiments, a second decanter is not needed for clarifying the barite recovery effluent. Instead, in example embodiments, this first effluent is immediately mixed with the inventive solution and then separated in the tricanter. Oil Mud weight is reduced from about 10.5 ppg to about 7.15 ppg. The density of the clarified oil is measured as about 0.853 g/cc, which is within the density range for diesel oil.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

1. A method of clarifying drilling mud, comprising:
mixing a hydrophilic solution and an effluent to create a mixture, said effluent comprising an oil lubricant and solid particles having a predetermined size,
binding the solid particles to the hydrophilic solution,
separating the oil lubricant from the solid particles; and
recovering the oil lubricant.

2. The method of claim 1, further wherein the oil lubricant is hydrophobic.

3. The method of claim 1, further comprising:
recycling the oil lubricant after the recovering step to a well, such that the oil lubricant lubricates at least one drilling component located in the well.

4. The method of claim 1, further comprising:
recovering and discharging the solid particles after the separating step.

5. The method of claim 1, further comprising:
recovering and recycling the hydrophilic solution after the separating step.

6. The method of claim 1, further comprising:
recovering and discharging the hydrophilic solution after the separating step.

7. The method of claim 1, further comprising:
mixing a mixture comprising about 20 percent to about 30 percent hydrophilic solution and from about 70 percent to about 80 percent effluent.

8. The method of claim 1, further comprising:
mixing a mixture comprising about 25 percent to about 30 percent hydrophilic solution and from about 70 percent to about 75 percent effluent.

9. The method of claim 1, further comprising:
heating the hydrophilic solution to about 140° F. before the mixing step.

10. A system for clarifying drilling mud, comprising:
a mixing tank for mixing a hydrophilic solution and an effluent, the effluent comprising an oil lubricant and solid particles having a predetermined size, and creating a mixture; and
a centrifuge connected to the mixing tank, the centrifuge being capable of receiving the mixture and separating the hydrophilic solution, the solid particles, and the oil lubricant, and discharging the separated oil lubricant.

11. The system of claim 10, further wherein:
the centrifuge is a three-stage tricanter.

12. The system of claim 10, further wherein the predetermined size is about 5 microns.

13. The system of claim 10, further wherein the predetermined size is less than 5 microns.

14. The system of claim 10, further wherein the mixture ranges from about 20 percent to about 30 percent hydrophilic solution and from about 70 percent to about 80 percent effluent.

15. The system of claim 10, further wherein the mixture ranges from about 25 percent to about 30 percent hydrophilic solution and from about 70 percent to about 75 percent effluent.

16. The system of claim 10, further wherein the centrifuge is capable of recovering and recycling the hydrophilic solution to the mixing tank for reuse.

17. The system of claim 10, further wherein the centrifuge is capable of recovering and discharging the solid particles.

18. The system of claim 10, further wherein the centrifuge is capable of separating the mixture at a speed ranging from about 2,000 rotations per minute to about 3,500 rotations per minute.

19. The system of claim 10, further comprising a centripetal pump connected to an outlet of the centrifuge such that the oil lubricant discharges by gravity flow.

20. The system of claim 10, further comprising means for controlling a flow of the effluent from the well at a temperature of about 120° F. to about 140° F. and at a rate of about 200 gallons per minute to about 250 gallons per minute.

21. The system of claim 10, further comprising:
means for heating the hydrophilic liquid or solution to about 140° F.

22. The system of claim 21, wherein the means for heating the hydrophilic solution is a heat exchanger.

23. The system of claim 10, wherein the mixing tank is jacketed.

24. A composition for clarifying drilling mud, comprising: a homogeneous mix of at least one hydrophilic substance chosen from the group consisting of: water, glycerin, propylene glycol, ethylene glycol, xylitol, sorbitol, glucose syrup, fructose syrup, and polymerized polyols.

25. The composition of claim 24, wherein the homogeneous mix has a density, at about 20° C., of between about 1.0 grams per cubic centimeter and about 1.226 grams per cubic centimeter.
